(19) United States
(12) Patent Application Publication
(10) Pub. No.: US 2007/0271307 A1
(43) Pub. Date: Nov. 22, 2007

(54) Write Sharing of Read-Only Data Storage Volumes

(76) Inventor: James R. Bergsten, Danville, CA (US)

Correspondence Address: GREENBERG TRAURIG, LLP (SV);IP DOCKETING, 2450 COLORADO AVENUE, SUITE 400E, SANTA MONICA, CA, 90404, US

(21) Appl. No.: 11/737,296

(22) Filed: Apr. 19, 2007

Related U.S. Application Data
(60) Provisional application No. 60/793,173, filed on Apr. 19, 2006.

(51) Int. Cl. G06F 17/30

(52) U.S. Cl. 707/200

(57) ABSTRACT

The present invention is directed to a system and method for efficient data storage, access and retrieval. An apparatus of the present invention may be a storage appliance, switch or director including multiple ports for connections with one or more processors, caches and servers and ports which couple to the data storage. The apparatus may be added to an existing storage system or may be integrated within a storage controller. The apparatus of the present invention may allow multiple processing instances to share a single copy of a data resource. The apparatus, however, prevents any modification to the base volume. Any modification to the data may be saved to a separate volume. The existence and location of modified data is maintained through metadata.

### RELATED APPLICATION

This application claims priority to Provisional Applications No. 60/793,173 entitled “Write Sharing of Read-Only Data Storage Volumes,” filed Apr. 19, 2006 which is incorporated herein by reference.

### BACKGROUND OF THE INVENTION

With the proliferation of discrete computing processors (such as servers and clients) and the rapidly growing acceptance of virtual machines, the amount of dedicated, nonvolatile data storage required to support these platforms is rapidly increasing. In particular, each processing device requires a largely identical, but discrete copy of the operating system, various applications, and related configuration data. The related configuration data may not be shared as the operating system and applications are designed assuming exclusive access to these resources.

Conventional storage systems also suffer from an inability to directly and efficiently share common, read-only data (such as historical databases). Many operating systems silently modify the volume and directories (for example, to update “date and time last accessed” information). Thus, the volume and directory data must be either replicated or shared through a less efficient networking protocol.

The cost and overhead of conventional storage systems is significant. In addition to the direct cost of each processing device, there is an ongoing expense of power, facilities, cooling, space, and especially maintenance to support each processing device. Each processing device must also be installed, configured, periodically upgraded, backed up, and so forth. As the number of processing devices increase, so does this overhead. This overhead is even more costly when it is needed just to create temporary processor instances (devices), for example, for applications testing, debugging, or training/education, as one must incur an equal expense for a modest benefit.

There is no known way at present to share operating system and applications across multiple processing instances. Application data can be shared via a number of existing networking protocols, such as the Networking File System (NFS) or the Common Internet File System (CIFS). However, these protocols rely on slower networking protocols, and require substantial file system knowledge and processing power at the data server.

Finally, most nonvolatile data storage is accessed through an intermediate high-speed data cache in order to improve access performance. Typically this cache resides in a storage controller and is shared amongst all of the data volumes attached to that controller. If multiple instances' data volumes are accessed through this controller, cache-optimization-based performance is greatly decreased because the storage controller unknowingly caches multiple copies of identical data.

Consequently, a method and system for efficient data storage, access and retrieval is necessary

### SUMMARY OF THE INVENTION

The present invention is directed to an apparatus and method for efficient data storage, access and retrieval. In one embodiment of the invention, an apparatus of the present invention may be a storage appliance, switch or director including multiple ports for connections with one or more processors, caches and servers and ports which couple to the data storage. The apparatus may be added to an existing storage system or may be integrated within a storage controller. Advantageously, the apparatus of the present invention may allow multiple processing instances to share a single copy of a data resource. By preventing modification of a base volume, the storage system of the present invention may prevent inadvertent and/or willful data corruption due to viruses, application bugs and so forth. Additionally, processing instances may be quickly and inexpensively added, deleted and reset. Replication of data may also be more efficient because common data only needs to be backed up once.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 depicts a block diagram of a storage system in accordance with an embodiment of the present invention; and

FIG. 2 depicts a flow chart depicting a method of storing data in accordance with an embodiment of the present invention.

### DETAILED DESCRIPTION OF THE INVENTION

Reference will now be made in detail to the presently preferred embodiments of the invention, examples of which are illustrated in the accompanying drawings.

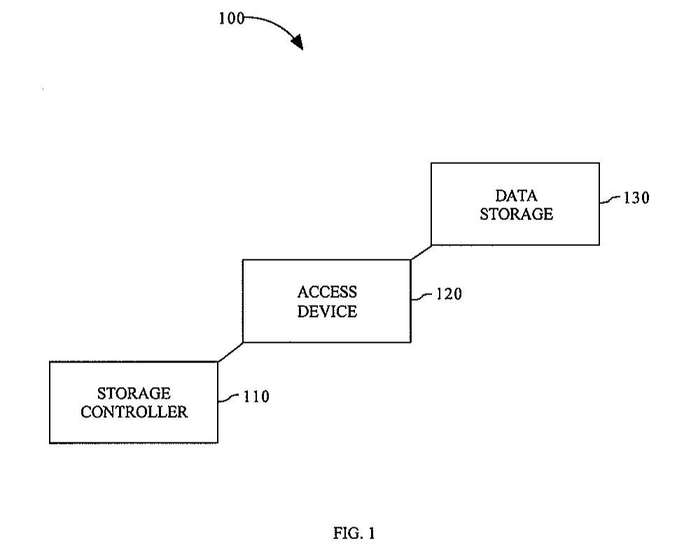

Referring to FIG. 1, a storage system 100 in accordance with the present invention is shown. Storage system 100 may include a storage controller 110, an access device 120 and data storage 130. An access device 120 of the present invention may be added to an existing storage system to allow multiple processing instances to share a single copy of a data resource along with additional functionality. Access device 120 may also be integrated within a storage controller 110 without departing from the scope and intent of the present invention. It is contemplated that in either implementation, access device 120 may operate in a transparent fashion to the storage controller 110

Access device 120 may be a storage appliance, switch or director including multiple ports for connections with one or more processors, caches and servers and ports which couple to the data storage. Access device 120 may be integrated within a storage system through coupling to processing instances, servers, caches and the like (instantly providing the benefits of this invention without requiring the addition, replacement and/or data migration of volumes).

In an alternative embodiment of the present invention, the access device may be coupled between a server and an unaltered storage system. With such an implementation, access device 120 may operate ahead of and separate from an entire storage system. This may be implemented without any modification to the server or storage system. In a second alternative embodiment of the invention, access device 120 may be coupled to a storage controller 110, the storage controller 110 being further coupled to data storage 130. In this implementation, access device 120 may operate in a transparent fashion to the storage controller 120.

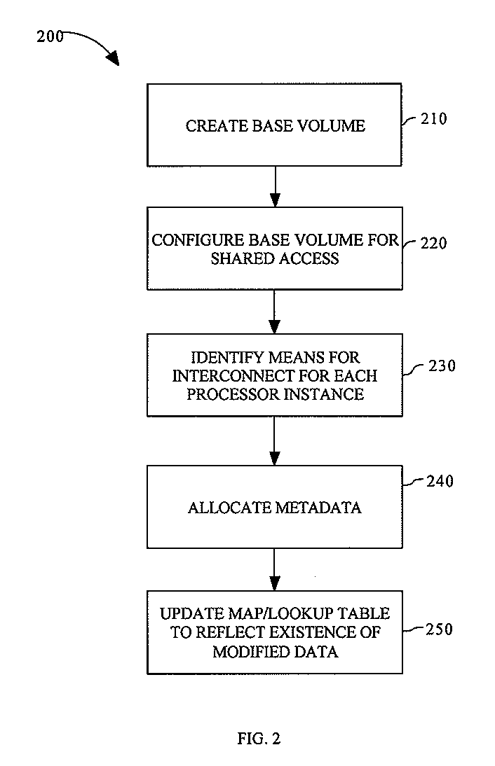

Referring to FIG. 2, a flow chart depicting a method 200 of storing data in accordance with an embodiment of the present invention. Method 200 may begin by creating a base volume 210. In this description, a “volume” implies a single volume or a plurality of volumes. A base volume may refer to a volume in its initial, unshared state, for example, a fresh installation of an operating system and commonly accessed applications. The next step may include configuring the base volume for shared access 220. Configuring may be performed by the access device 120 of FIG. 1 when the device is discrete, otherwise, configuring may be performed by the storage controller 110 when the access device 120 is embedded within the storage controller 110. Additionally, the means of interconnect for each processor instance may be identified 230. Each processor instance may be identified by its connection path(s) and its address. “Means of interconnect” might include the physical connection port(s), and the volume's address (in SCSI protocols, this would be the volume's target identifier and logical unit number).

At this point, each processor instance may have logical “read/write” access to the volume, but no processor instance can modify the base volume directly. Appropriate metadata (such as maps and lookup tables) may be allocated 240. When an instance writes to the volume, the write data are saved to a location other than the base physical volume. These write data may be saved on either volumes that are internal or external to the embodiment (based on volume capacity and how the implementation is configured by the user). Both a map and a lookup table are updated to reflect the existence and location of the modified data 250. Based on implementation, subsequent writes to the same data may either be overlaid (so that only the latest copy of data exist), or a separate copy created (to allow reversion of the volume to any particular point in time).

When an instance reads from the volume, the map is first consulted to determine whether the data have previously been modified by this instance. If so, the modified data are returned from the location pointed to by the lookup table; otherwise the unmodified data are returned from the base volume.

At any point, a processing instance (and all of its modified data) may be removed (because it is no longer in use), or an instance may be configured to revert to a previous (or completely unmodified base) state (for restarting a test, re-running an application, removing a virus, etc.).

At any point, all instances, and all modified data may be discarded (for example, after a training class ends and before a new training class begins).

Finally, when all instances are stopped, the modified data from any one particular instance can be copied to the base volume, making it the new base volume. This may be done to upgrade the base operating system, applications, and so forth.

In all three preceding cases, obsolete data, cached data, maps, and lookup tables are discarded (making the freed resources available for subsequent use). Any number of volumes may be shared by any number of processor instances—multiple instances may share the same or disparate volumes. For instance, all instances running the same operating system may share the same operating system volume, but a subset may also share a specific applications-dependent database.

The location and access method of the base volume and the modified data are implementation dependent—they may be local or remote, and there may be duplicate, geographically disparate cache-coherent copies to improve performance.

It is believed that the method and system of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. A method of storing data comprising:
creating a base volume at an initial state;
configuring the base volume to be shared by at least one processor instance, the at least one processor instance capable of writing to the base volume without modifying data in the base volume;
identifying connection between the base volume and the at least one processor instance;
allocating metadata to the at least one processor instance; and
updating the metadata to track data in the base volume modified by the at least one processor instance.

2. The method of claim 1 further comprising saving the modified data in another volume to prevent modification to the base volume.

3. The method of claim 1 wherein the updating the metadata includes tracking existence and location of the modified data.

4. The method of claim 1 wherein the metadata is a lookup table or map indicating existence and location of the modified data.

5. The method of claim 1 wherein the base volume includes an operating system or a software application.

6. The method of claim 1 wherein the configuring the base volume is performed at an access device.

7. The method of claim 1 wherein the access device is embedded in a storage controller.

8. The method of claim 1 wherein the identifying connection includes a connection path and address of the at least one processor instance.

9. A storage system comprising:
a data storage having a base volume data;
a storage controller coupled to the data storage; and
an access device that communicates with the storage controller and data storage to provide the base volume data to at least one processor without modifying the base volume data, wherein a separate volume data is created to include modified base volume data.

10. The system of claim 9 wherein the access device provides the base volume data to a server or cache.

11. The system of claim 9 further comprising metadata at the access device including location information of the modified data.

12. The system of claim 11 wherein the metadata is a lookup table or map.

13. The system of claim 9 wherein the base volume includes an operating system or a software application.

14. The system of claim 9 wherein the access device is integral to the storage controller.

15. The system of claim 9 wherein the access device is a storage appliance, switch or director.

16. The system of claim 9 wherein the access device includes a port for connection with the at least one processor.

17. The system of claim 9 wherein the base volume data and modified volume data reside at the data storage.
